(19) United States
(12) Patent Application Publication
(10) Pub. No.: US 2022/0260884 A1
(43) Pub. Date: Aug. 18, 2022

(54) CONTROLLED REFLECTANCE IN ELECTROCHROMIC DEVICES

(71) Applicant: SAGE ELECTROCHROMICS, INC., Faribault, MN (US)

(72) Inventors: Robert J. ANGLEMIER, Waterville, MN (US); Cody VanDerVeen, Faribault, MN (US); Jean-Christophe Giron, Edina, MN (US)

(21) Appl. No.: 17/650,424

(22) Filed: Feb. 9, 2022

Related U.S. Application Data
(60) Provisional application No. 63/148,826, filed on Feb. 12, 2021.

(51) Int. Cl. G02F 1/1523; G02F 1/157; G02F 1/163

(52) U.S. Cl. CPC G02F 1/1523; G02F 1/163; G02F 1/157

(57) ABSTRACT

A laminate electrochromic device is disclosed. The laminate device can include a substrate and a laminate layer. The laminate layer can reflect wavelengths between 300 nm and 400 nm. The laminate device can also include a first transparent conductive layer between the substrate and the laminate layer and the substrate, a second transparent conductive layer between the substrate and the laminate layer and the substrate, a cathodic electrochromic layer between the first transparent conductive layer and the second transparent conductive layer, and an anodic electrochromic layer between the first transparent conductive layer and the second transparent conductive layer.

### CROSS-REFERENCE TO RELATED APPLICATIONS

This application claims priority under 35 U.S.C § 119(e) to U.S. Provisional Application No. 63/148,826, entitled “CONTROLLED REFLECTANCE IN ELECTROCHROMIC DEVICES,” by Robert J. ANGLEMIER et al., filed Feb. 12, 2021, which is assigned to the current assignee hereof and is incorporated herein by reference in its entirety.

### FIELD OF THE DISCLOSURE

The present disclosure is related to electrochemical devices and method of forming the same.

### BACKGROUND

An electrochemical device can include an electrochromic stack where transparent conductive layers are used to provide electrical connections for the operation of the stack. Electrochromic (EC) devices employ materials capable of reversibly altering their optical properties following electrochemical oxidation and reduction in response to an applied potential. Electrochromic devices alter the color, transmittance, absorbance, and reflectance of energy by inducing a change the electrochemical material. Specifically, the optical modulation is the result of the simultaneous insertion and extraction of electrons and charge compensating ions in the electrochemical material lattice. Advances in electrochromic devices seek to have devices with faster and more homogeneous switching speeds while maintaining an aesthetically pleasing view.

As such, further improvements are sought in manufacturing electrochromic devices.

### BRIEF DESCRIPTION OF THE DRAWINGS

FIG. 1 is a schematic cross-section of an electrochromic device, according to one embodiment.

FIG. 2 is a schematic cross-section of an electrochromic device, according to one embodiment.

FIGS. 3A-3B are schematic top views of one or more electrochromic with a patterned laminate layer, as described above.

FIG. 4 is a schematic illustration of an insulated glazing unit, according the embodiment of the current disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific embodiments and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated.

Patterned features, which include bus bars, holes, holes, etc., can have a width, a depth or a thickness, and a length, wherein the length is greater than the width and the depth or thickness. As used in this specification, a diameter is a width for a circle, and a minor axis is a width for an ellipse.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

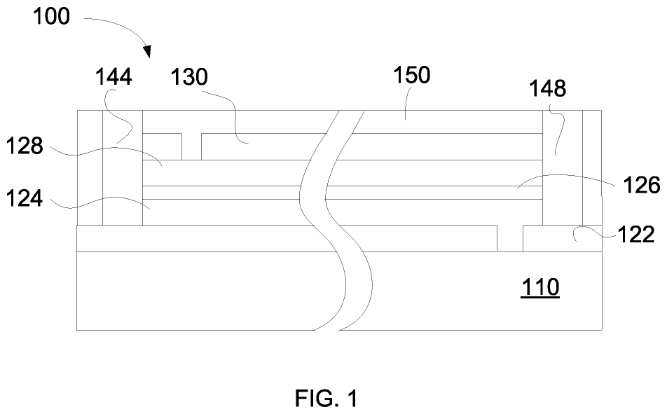

In accordance with the present disclosure, FIG. 1 illustrates a cross-section view of a partially fabricated electrochemical device 100 having an improved film structure. For purposes of illustrative clarity, the electrochemical device 100 is a variable transmission device. In one embodiment, the electrochemical device 100 can be an electrochromic device. In another embodiment, the electrochemical device 100 can be a thin-film battery. However, it will be recognized that the present disclosure is similarly applicable to other types of scribed electroactive devices, electrochemical devices, as well as other electrochromic devices with different stacks or film structures (e.g., additional layers). With regard to the electrochemical device 100 of FIG. 1, the device 100 may include a substrate 110 and a stack overlying the substrate 110. The stack may include a first transparent conductor layer 122, a cathodic electrochemical layer 124, an anodic electrochemical layer 128, and a second transparent conductor layer 130. In one embodiment, the stack may also include an ion conducting layer 126 between the cathodic electrochemical layer 124 and the anodic electrochemical layer 128, and a UV reflective laminate layer 150 over the entire stack.

In an embodiment, the substrate 110 can include a glass substrate, a sapphire substrate, an aluminum oxynitride substrate, or a spinel substrate. In another embodiment, the substrate 110 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 110 may or may not be flexible. In a particular embodiment, the substrate 110 can be float glass or a borosilicate glass and have a thickness in a range of 0.5 mm to 12 mm thick. The substrate 110 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm. In another particular embodiment, the substrate 110 can include ultra-thin glass that is a mineral glass having a thickness in a range of 50 microns to 300 microns. In a particular embodiment, the substrate 110 may be used for many different electrochemical devices being formed and may referred to as a motherboard.

Transparent conductive layers 122 and 130 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 122 and 130 can include gold, silver, copper, nickel, aluminum, or any combination thereof. The transparent conductive layers 122 and 130 can include indium oxide, indium tin oxide, doped indium oxide, tin oxide, doped tin oxide, zinc oxide, doped zinc oxide, ruthenium oxide, doped ruthenium oxide and any combination thereof. The transparent conductive layers 122 and 130 can have a thickness between 10 nm and 600 nm. In one embodiment, the transparent conductive layers 122 and 130 can have a thickness between 200 nm and 500 nm. In one embodiment, the transparent conductive layers 122 and 130 can have a thickness between 320 nm and 460 nm. In one embodiment the first transparent conductive layer 122 can have a thickness between 10 nm and 600 nm. In one embodiment, the second transparent conductive layer 130 can have a thickness between 80 nm and 600 nm.

The layers 124 and 128 can be electrode layers, wherein one of the layers may be a cathodic electrochemical layer, and the other of the layers may be an anodic electrochromic layer (also referred to as a counter electrode layer). In one embodiment, the cathodic electrochemical layer 124 is an electrochromic layer. The cathodic electrochemical layer 124 can include an inorganic metal oxide material, such as WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), or any combination thereof and can have a thickness in a range of 40 nm to 600 nm. In one embodiment, the cathodic electrochemical layer 124 can have a thickness between 100 nm to 400 nm. In one embodiment, the cathodic electrochemical layer 124 can have a thickness between 350 nm to 390 nm. The cathodic electrochemical layer 124 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof.

The anodic electrochromic layer 128 can include any of the materials listed with respect to the cathodic electrochromic layer 124 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the anodic electrochromic layer 128 can have a thickness between 150 nm to 300 nm. In one embodiment, the anodic electrochromic layer 128 can have a thickness between 250 nm to 290 nm. In some embodiments, lithium may be inserted into at least one of the first electrode 130 or second electrode 140.

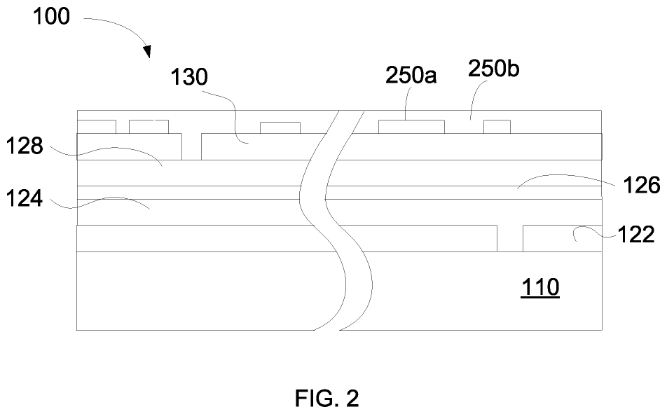

The laminate layer 150 can be over the entire device. In one embodiment, the laminate layer 150 can seal and protect the device from the exterior environment as well as reflect light in the ultraviolet range. In one embodiment, the laminate layer 150 can include ZrO₂, ThO₂, SiO₂, fluorescent material, phosphorescence material, quartz, and any combination thereof. The laminate layer 150 can have a sideband suppression to amplify the output signal. In one embodiment, the sideband suppression can be air-⅛H-¼L-¼H-¼L-⅛H-glass. A single sideband modulation or suppression is when only the upper sideband or the lower sideband is transmitted. In other words, single sideband (SSB) system consists in transmitting only one sideband and suppressed the other sideband and the carrier wave. A SSB advantageously allows a transmission free of distortion. The SSB can be measured using a filter method, phase-shift method, or weaver's method. In one embodiment, the laminate layer 150 can reflect wavelengths between 300 nm and 400 nm. In another embodiment, the laminate layer 150 can be patterned as seen in FIG. 2, and described in more detail below.

In another embodiment, the device 100 may include a plurality of layers between the substrate 110 and the first transparent conductive layer 122. In one embodiment, an antireflection layer can be between the substrate 110 and the first transparent conductive layer 122. The antireflection layer can include SiO₂, NbO₂, Nb₂O₅ and can be a thickness between 20 nm to 100 nm. The device 100 may include at least two bus bars with one bus bar 144 electrically connected to the first transparent conductive layer 122 and the second bus bar 148 electrically connected to the second transparent conductive layer 130.

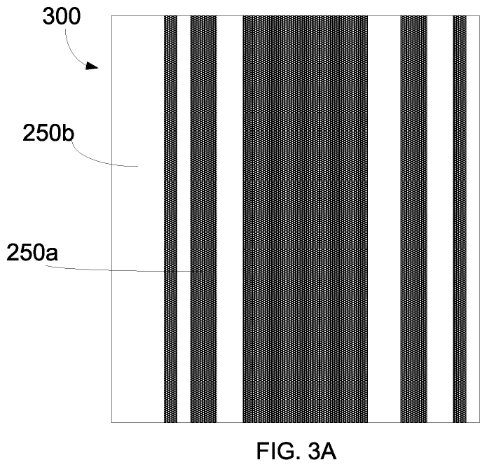

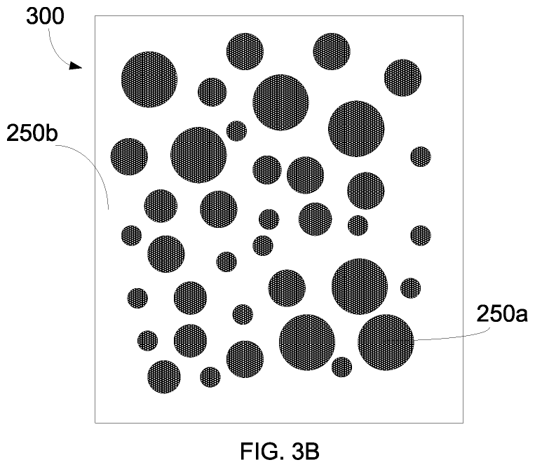

FIG. 2 is a schematic cross-section of an electrochromic device 200, according to another embodiment. The electrochromic device 200 can include additional layers and embodiments, such as seen in FIG. 2. The electrochromic device 200 of FIG. 2 is substantially similar to the electrochromic device 100 of FIG. 1. In fact, the electrochromic device 200 of FIG. 2 is a variant of the embodiment of FIG. 1, in which equivalent elements have been given identical reference numbers. As such, only additional features or differences from FIG. 1 are described below. FIG. 2 can include a laminate layer 150 that is patterned. FIGS. 3A-3B are schematic top views of one or more electrochromic with a patterned laminate layer, as described above. The one or more electrochromic devices electrochromic devices 300 can be the same as the electrochromic device 100 described above. In one embodiment, as seen in FIG. 3A, the pattern can be a striped pattern. In one embodiment, the stripes can be uniform in width. In another embodiment, the stripes can be non-uniform. In one embodiment, the pattern can be random. The pattern can be formed by selectively etching the layer 250a and depositing the layer 250b. In one embodiment, the laminate layer 250a can reflect a first wavelength and the laminate layer 250b can reflect a second wavelength different from the first wavelength where both the first and second wavelengths are in the ultraviolet range. In one embodiment, the laminate layer 250a can reflect wavelengths between 300 nm and 320 nm and the laminate layer 250b can reflect wavelengths between 320 nm and 400 nm. In another embodiment, the laminate layer 250a can reflect wavelengths between 300 nm and 350 nm and the laminate layer 250b can reflect wavelengths between 350 nm and 400 nm. In another embodiment, the laminate layer 250a can reflect wavelengths between 300 nm and 400 nm and the laminate layer 250b can reflect wavelengths between 420 nm and 660 nm. In one embodiment, the pattern includes squares, triangles, circles, hexagonal, pentagons, rectangles, checkered pattern, other geometric shapes, and combinations thereof.

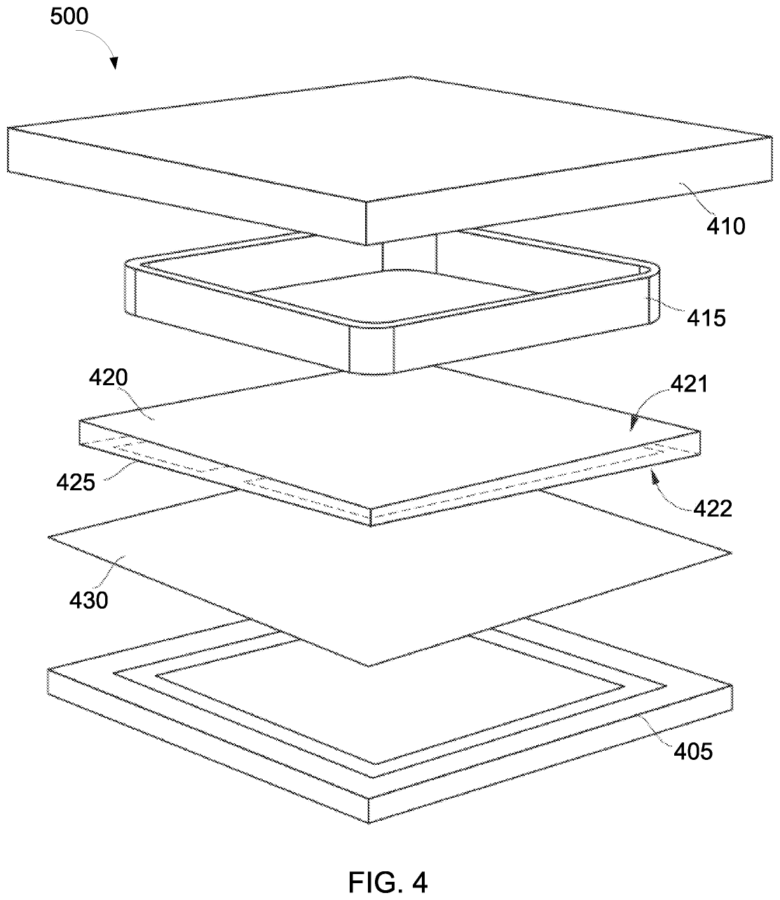

Any of the laminate devices can be subsequently processed as a part of an insulated glass unit. FIG. 4 is a schematic illustration of an insulated glazing unit 400 according the embodiment of the current disclosure. The insulated glass unit 400 can include a first panel 405, an electrochemical device 420 coupled to the first panel 405, a second panel 410, and a spacer 415 between the first panel 405 and second panel 410. The first panel 405 can be a glass panel, a sapphire panel, an aluminum oxynitride panel, or a spinel panel. In another embodiment, the first panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The first panel 405 may or may not be flexible. In a particular embodiment, the first panel 405 can be float glass or a borosilicate glass and have a thickness in a range of 2 mm to 20 mm thick. The first panel 405 can be a heat-treated, heat-strengthened, or tempered panel. In one embodiment, the electrochemical device 420 is coupled to first panel 405. In another embodiment, the electrochemical device 420 is on a substrate 425 and the substrate 425 is coupled to the first panel 405. In one embodiment, a lamination interlayer 530 may be disposed between the first panel 405 and the electrochemical device 420. In one embodiment, the lamination interlayer 430 may be disposed between the first panel 405 and the substrate 425 containing the electrochemical device 420. The electrochemical device 420 may be on a first side 421 of the substrate 425 and the lamination interlayer 430 may be coupled to a second side 422 of the substrate. The first side 421 may be parallel to and opposite from the second side 422.

The second panel 410 can be a glass panel, a sapphire panel, an aluminum oxynitride panel, or a spinel panel. In another embodiment, the second panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The second panel may or may not be flexible. In a particular embodiment, the second panel 410 can be float glass or a borosilicate glass and have a thickness in a range of 5 mm to 30 mm thick. The second panel 410 can be a heat-treated, heat-strengthened, or tempered panel. In one embodiment, the spacer 415 can be between the first panel 405 and the second panel 4510. In another embodiment, the spacer 415 is between the substrate 425 and the second panel 410. In yet another embodiment, the spacer 415 is between the electrochemical device 420 and the second panel 410.

In another embodiment, the insulated glass unit 400 can further include additional layers. The insulated glass unit 400 can include the first panel, the electrochemical device 420 coupled to the first panel 405, the second panel 410, the spacer 415 between the first panel 405 and second panel 410, a third panel, and a second spacer between the first panel 405 and the second panel 410. In one embodiment, the electrochemical device may be on a substrate. The substrate may be coupled to the first panel using a lamination interlayer. A first spacer may be between the substrate and the third panel. In one embodiment, the substrate is coupled to the first panel on one side and spaced apart from the third panel on the other side. In other words, the first spacer may be between the electrochemical device and the third panel. A second spacer may be between the third panel and the second panel. In such an embodiment, the third panel is between the first spacer and second spacer. In other words, the third panel is couple to the first spacer on a first side and coupled to the second spacer on a second side opposite the first side.

The embodiments described above and illustrated in the figures are not limited to rectangular shaped devices. Rather, the descriptions and figures are meant only to depict cross-sectional views of a device and are not meant to limit the shape of such a device in any manner. For example, the device may be formed in shapes other than rectangles (e.g., triangles, circles, arcuate structures, etc.). For further example, the device may be shaped three-dimensionally (e.g., convex, concave, etc.).

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. A laminate electrochromic device comprising: a substrate; a laminate layer, wherein the laminate layer reflects wavelengths between 300 nm and 400 nm; a first transparent conductive layer between the substrate and the laminate layer and the substrate; a second transparent conductive layer between the substrate and the laminate layer and the substrate; a cathodic electrochromic layer between the first transparent conductive layer and the second transparent conductive layer; and an anodic electrochromic layer between the first transparent conductive layer and the second transparent conductive layer.

Embodiment 2. The laminate electrochromic device of Embodiment 1, wherein the laminate layer comprises fluorescent material.

Embodiment 3. The laminate electrochromic device of Embodiment 1, wherein the laminate layer comprises ZrO₂, ThO₂, SiO₂, fluorescent material, phosphorescence material, quartz, and any combination thereof.

Embodiment 4. The laminate electrochromic device of Embodiment 1, wherein the laminate layer is patterned.

Embodiment 5. The laminate electrochromic device of Embodiment 4, wherein the pattern is uniform and extends across the entire electrochromic device.

Embodiment 6. The laminate electrochromic device of Embodiment 4, wherein the pattern includes squares, triangles, circles, hexagonal, pentagons, rectangles, checkered pattern, other geometric shapes, and combinations thereof.

Embodiment 7. The laminate electrochromic device of Embodiment 4, wherein the pattern is non-uniform.

Embodiment 8. The laminate electrochromic device of Embodiment 1, wherein the laminate layer comprises a sideband suppression.

Embodiment 9. The laminate electrochromic device of Embodiment 1, wherein the sideband suppression is air-⅛H-¼L-¼H-¼L-⅛H-glass.

Embodiment 10. The laminate electrochromic device of Embodiment 1, wherein the substrate comprises glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

Embodiment 11. The laminate electrochromic device of Embodiment 1, wherein each of the one or more electrochromic devices further comprises an ion conducting layer between the cathodic electrochemical layer and the anodic electrochemical layer.

Embodiment 12. The laminate electrochromic device of Embodiment 11, wherein the ion-conducting layer comprises lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

Embodiment 13. The laminate electrochromic device of Embodiment 1, wherein the electrochromic layer comprises WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 14. The laminate electrochromic device of Embodiment 1, wherein the first transparent conductive layer comprises indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 15. The laminate electrochromic device of Embodiment 1, wherein the second transparent conductive layer comprises indium oxide, indium tin oxide, doped indium oxide, tin oxide, doped tin oxide, zinc oxide, doped zinc oxide, ruthenium oxide, doped ruthenium oxide and any combination thereof.

Embodiment 16. The laminate electrochromic device of Embodiment 1, wherein the anodic electrochemical layer comprises a an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

Embodiment 17. A laminate electrochromic device comprising: a substrate; a laminate layer, wherein the laminate layer comprises two different materials and wherein the first material reflects a first wavelength between 300 nm and 380 nm and the second material reflects a second wavelength between 380 nm and 420 nm; a first transparent conductive layer between the substrate and the laminate layer and the substrate; a second transparent conductive layer between the substrate and the laminate layer and the substrate; a cathodic electrochromic layer between the first transparent conductive layer and the second transparent conductive layer; and an anodic electrochromic layer between the first transparent conductive layer and the second transparent conductive layer.

Embodiment 18. The laminate electrochromic device of Embodiment 17, wherein the first wavelength is between 300 nm and 350 nm.

Embodiment 19. The laminate electrochromic device of Embodiment 17, wherein the second wavelength is between 380 nm and 400 nm.

Embodiment 20. A laminate electrochromic device comprising: a substrate; a laminate layer, wherein the laminate layer comprises a fluorescent material; a first transparent conductive layer between the substrate and the laminate layer and the substrate; a second transparent conductive layer between the substrate and the laminate layer and the substrate; a cathodic electrochromic layer between the first transparent conductive layer and the second transparent conductive layer; and an anodic electrochromic layer between the first transparent conductive layer and the second transparent conductive layer.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A laminate electrochromic device comprising:
a substrate;
a laminate layer, wherein the laminate layer reflects wavelengths between 300 nm and 400 nm;
a first transparent conductive layer between the substrate and the laminate layer and the substrate;
a second transparent conductive layer between the substrate and the laminate layer and the substrate;
a cathodic electrochromic layer between the first transparent conductive layer and the second transparent conductive layer; and
an anodic electrochromic layer between the first transparent conductive layer and the second transparent conductive layer.

2. The laminate electrochromic device of claim 1, wherein the laminate layer comprises fluorescent material.

3. The laminate electrochromic device of claim 1, wherein the laminate layer comprises ZrO₂, ThO₂, SiO₂, fluorescent material, phosphorescence material, quartz, and any combination thereof.

4. The laminate electrochromic device of claim 1, wherein the laminate layer is patterned.

5. The laminate electrochromic device of claim 4, wherein the pattern is uniform and extends across the entire electrochromic device.

6. The laminate electrochromic device of claim 4, wherein the pattern includes squares, triangles, circles, hexagonal, pentagons, rectangles, checkered pattern, other geometric shapes, and combinations thereof.

7. The laminate electrochromic device of claim 4, wherein the pattern is non-uniform.

8. The laminate electrochromic device of claim 1, wherein the laminate layer comprises a sideband suppression.

9. The laminate electrochromic device of claim 8, wherein the sideband suppression is air-⅛H-¼L-¼H-¼L-⅛H-glass.

10. The laminate electrochromic device of claim 1, wherein the substrate comprises glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

11. The laminate electrochromic device of claim 1, wherein each of the one or more electrochromic devices further comprises an ion conducting layer between the cathodic electrochemical layer and the anodic electrochemical layer.

12. The laminate electrochromic device of claim 11, wherein the ion-conducting layer comprises lithium, sodium, hydrogen, deuterium, potassium, calcium, barium, strontium, magnesium, oxidized lithium, Li₂WO₄, tungsten, nickel, lithium carbonate, lithium hydroxide, lithium peroxide, or any combination thereof.

13. The laminate electrochromic device of claim 1, wherein the electrochromic layer comprises WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

14. The laminate electrochromic device of claim 1, wherein the first transparent conductive layer comprises indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

15. The laminate electrochromic device of claim 1, wherein the second transparent conductive layer comprises indium oxide, indium tin oxide, doped indium oxide, tin oxide, doped tin oxide, zinc oxide, doped zinc oxide, ruthenium oxide, doped ruthenium oxide and any combination thereof.

16. The laminate electrochromic device of claim 1, wherein the anodic electrochemical layer comprises a an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

17. A laminate electrochromic device comprising:
a substrate;
a laminate layer, wherein the laminate layer comprises two different materials and wherein the first material reflects a first wavelength between 300 nm and 380 nm and the second material reflects a second wavelength between 380 nm and 420 nm;
a first transparent conductive layer between the substrate and the laminate layer and the substrate;
a second transparent conductive layer between the substrate and the laminate layer and the substrate;
a cathodic electrochromic layer between the first transparent conductive layer and the second transparent conductive layer; and
an anodic electrochromic layer between the first transparent conductive layer and the second transparent conductive layer.

18. The laminate electrochromic device of claim 17, wherein the first wavelength is between 300 nm and 350 nm.

19. The laminate electrochromic device of claim 17, wherein the second wavelength is between 380 nm and 400 nm.

20. A laminate electrochromic device comprising:
a substrate;
a laminate layer, wherein the laminate layer comprises a fluorescent material;
a first transparent conductive layer between the substrate and the laminate layer and the substrate;
a second transparent conductive layer between the substrate and the laminate layer and the substrate;
a cathodic electrochromic layer between the first transparent conductive layer and the second transparent conductive layer; and
an anodic electrochromic layer between the first transparent conductive layer and the second transparent conductive layer.
